(19) United States
(12) Patent Application Publication
(10) Pub. No.: US 2006/0289184 A1
(43) Pub. Date: Dec. 28, 2006

(54) Pneumatic tool

(76) Inventor: Ming-Ta Cheng, Yuanli Chen (TW)

Correspondence Address: HERSHKOVITZ & ASSOCIATES, 2845 DUKE STREET, ALEXANDRIA, VA, 22314, US

(21) Appl. No.: 11/165,405

(22) Filed: Jun. 24, 2005

(51) Int. Cl. B23B 45/04

(52) U.S. Cl. 173/168

(57) ABSTRACT

A pneumatic tool has a body, a chuck bracket, an exhaust ring and a noise suppressor. The body has a recess and multiple exhaust channels. The exhaust channels are respectively defined in the recess. The chuck bracket is mounted on the front end of the body. The exhaust ring is mounted on the recess in the body and has multiple exhaust channels defined in the exhaust ring. The noise suppressor is mounted between the recess in the body and the exhaust ring, and is made of a material that absorbs sound and air.

### BACKGROUND OF THE INVENTION

1. Field of Invention

The present invention relates to a pneumatic tool, more particularly to a pneumatic tool having noise suppressors.

2. Description of the Related Art

With reference to FIG. 10, a conventional pneumatic tool has a chuck bracket (50), a body (51) and an exhaust ring (53).

The body (51) has a front end, a rear end, an outer surface, a rotor (52), a recess (510) and multiple exhaust channels (511). The rotor (52) is mounted on the front end of the body (51). The recess (510) is defined in an outer surface at the front end of the body (51). The multiple exhaust channels (511) are respectively defined in a periphery defining recess (510).

The chuck bracket (50) is mounted on the front end of the body (51).

The exhaust ring (53) is mounted on the recess (510) in the body (51) and has multiple exhaust channels (530). The multiple exhaust channels (530) are defined in the exhaust ring (53) for venting used air.

However, when air exhausts from the exhaust channels (511, 530), it will make a loud noise, often 98 decibels and above. The cacophony will make a user who is using the pneumatic tool feel annoyed and impatient, furthermore, the loud noise hurts users' ears. Also, although mufflers may be mounted on the pneumatic tools, they will make whole the pneumatic tool become too bulky.

Thus, a real need exists for a pneumatic tool that is quiet and has a small physical volume.

### SUMMARY OF THE INVENTION

The primary objective of the present invention is to provide a pneumatic tool that has a noise suppressor.

The pneumatic tool in accordance with the present invention has a body, a chuck bracket, an exhaust ring and a noise suppressor. The body has a recess and multiple exhaust channels. The exhaust channels are respectively defined in a periphery defining recess. The chuck bracket is mounted on the front end of the body. The exhaust ring is mounted on the recess in the body and multiple exhaust channels are defined in the exhaust ring. The noise suppressor is mounted between the recess in the body and the exhaust ring, and is made of a piece of material that is sound absorbent and air absorbent.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a pneumatic tool in accordance with the present invention;

FIG. 2 is an exploded perspective view of the pneumatic tool in FIG. 1;

FIG. 3 is an exploded perspective view of a second embodiment of the pneumatic tool in accordance with the present invention;

FIG. 4 is an exploded perspective view of a third embodiment of a pneumatic tool in accordance with the present invention;

FIG. 5 is a side plan view of in partial section of the pneumatic tool in FIG. 2;

FIG. 6 is a side plan view in partial section of the pneumatic tool along line 6-6 in FIG. 5;

FIG. 7 is a side plan in partial section of the pneumatic tool in FIG. 2 with air passing through a noise suppressor;

FIG. 8 is an explode perspective view of a fourth embodiment of a pneumatic tool in accordance with the present invention;

FIG. 9 is a perspective view in partial section of the pneumatic tool in FIG. 8; and

FIG. 10 is an exploded perspective view of a pneumatic tool in accordance with the prior art.

### DETAILED DESCRIPTION OF THE INVENTION

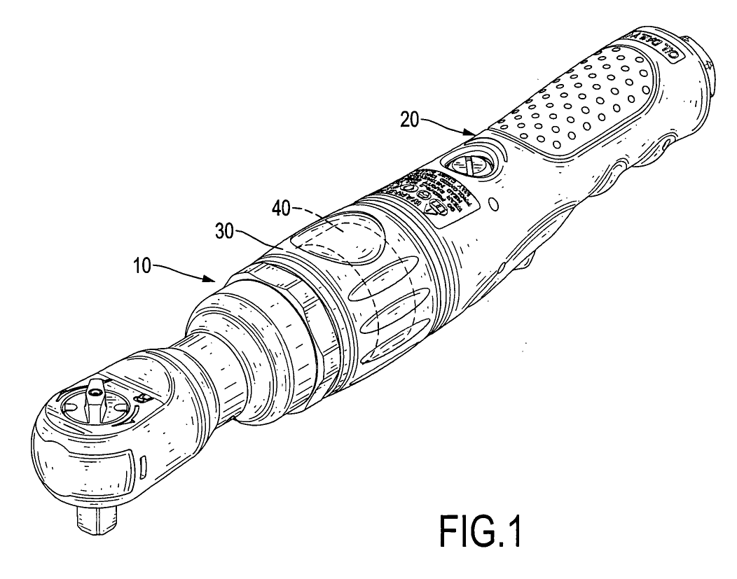

With reference to FIGS. 1 to 4 and FIG. 6, a pneumatic tool in accordance with the present invention has a chuck bracket (10), a body (20), an exhaust ring (30) and a noise suppressor (40, 40A, 40B).

The body (20) has a diameter, a front end, an outer surface, a recess (21), multiple exhaust channels (210), a rotor (25) and a cylinder (26). The recess (21) is defined in the outer surface of the body near the front end of the body (20) and has a diameter. The diameter of the recess (21) is smaller than the diameter of the body (20). The exhaust channels (210) are respectively defined in a periphery defining recess (21) for venting spent air. The rotor (25) is mounted inside the body (20) and near the front end. The cylinder (26) is mounted inside the body (20) and surrounds the rotor (25).

The chuck bracket (10) is mounted on the front end of the body (20) and is used for connecting a tool chuck, such as a drill.

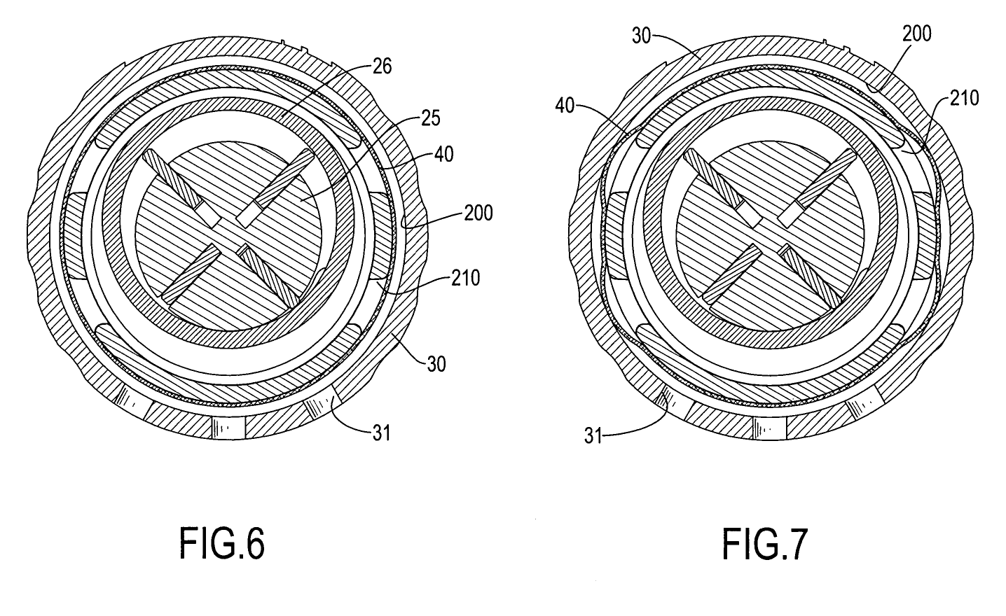

The exhaust ring (30) is mounted over the recess (21) in the body (20) and has multiple exhaust channels (31) that vent exhausted air. With reference to FIG. 6, when the exhaust ring (30) is mounted over the recess (21) in the body (20), a chamber (200) is formed.

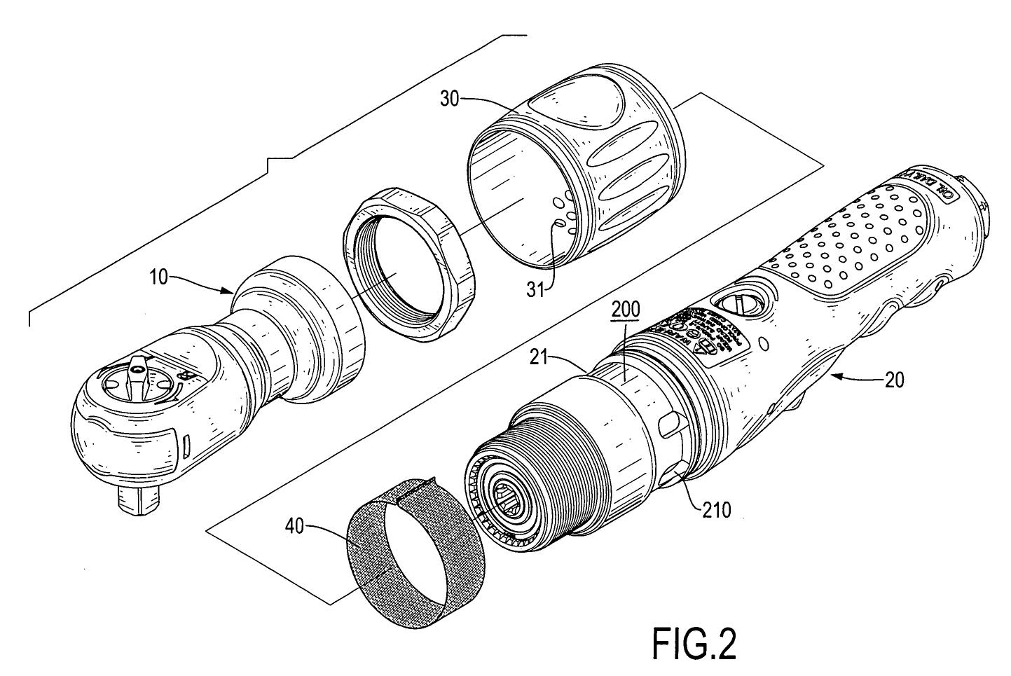

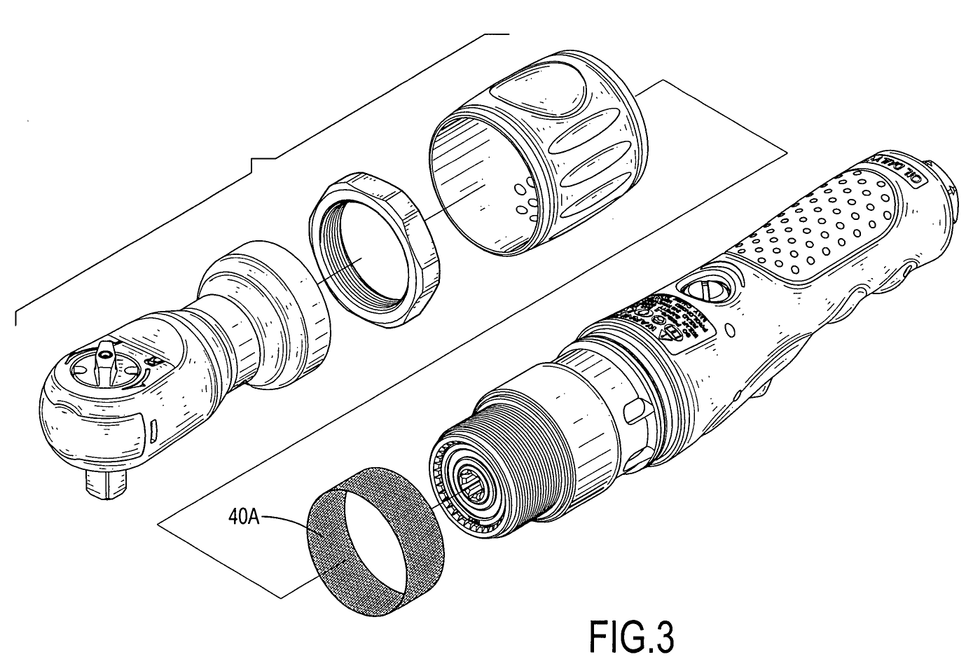

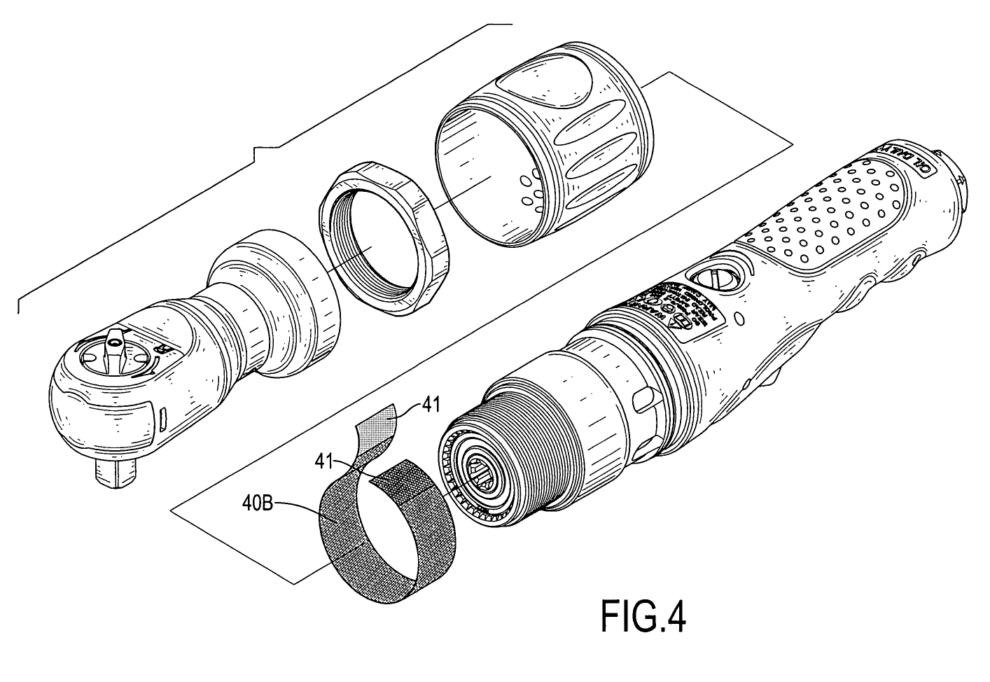

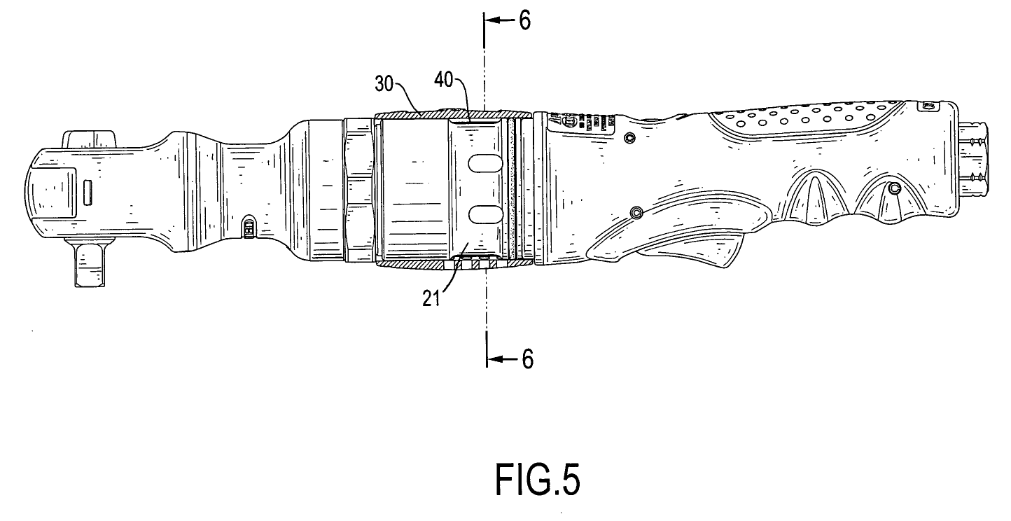

The noise suppressor (40, 40A, 40B) is mounted on the recess (21) in the body (20) and seals the exhaust channels (210) in the body (20). The noise suppressor (40, 40A, 40B) may be a belt, a loop etc. The noise suppressor (40, 40A, 40B) may be made of textile, resilient material, plastic material or material that can absorb noise. The noise suppressor (40, 40A, 40B) should be a porous, resilient material and must be very thin for mounting inside the chamber (200) between the recess (21) and the exhaust ring (30). With reference to FIGS. 2 and 4, the noise suppressor (40, 40B) is belt having two ends and two optional connectors (41). The two ends of the belt (40, 40B) may connect together by stitching or the connectors (41). With reference to FIG. 3, the noise suppressor (40A) also may be a loop.

With reference to FIG. 7, when the pneumatic tool in accordance with the present invention is used, pressured air from an air compressor drives the rotor (25) and exhausted air is released via the exhaust channels (210) in the recess (21) and the exhaust channels (31) in the exhaust ring (30). The noise suppressor (40) will sway inside the chamber (200) caused by the venting spent air. Because the noise suppressor (40, 40A, 40B) is made of a material that can absorb noise and is attached on the exhaust channels (210), the noise made from the pneumatic tool will be reduced.

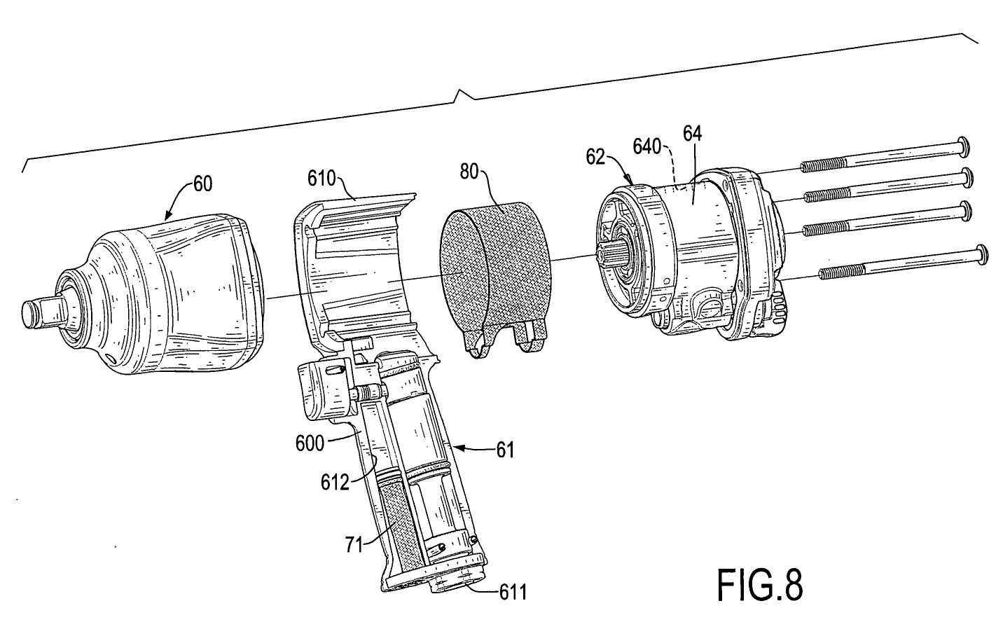

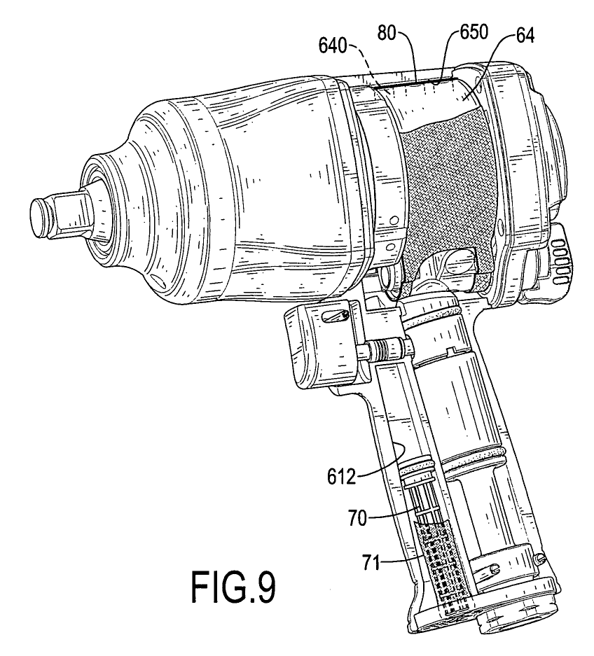

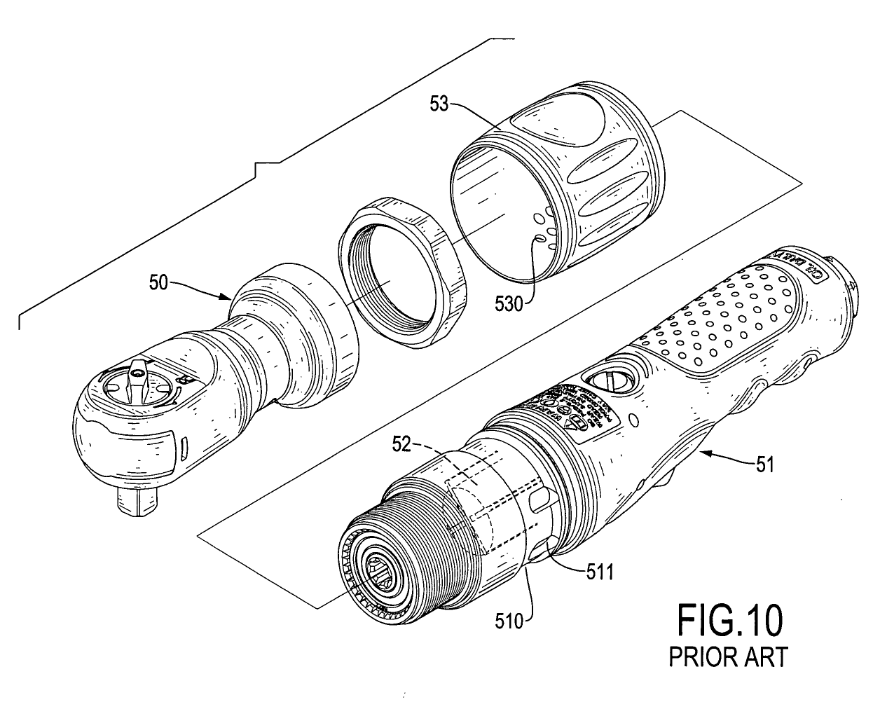

With reference to FIGS. 8 and 9, a fourth embodiment of the pneumatic tool in accordance with the present invention has a chuck head (60), two semi-housings (61), a body (62), a muffler (70) and a first noise suppressor (80).

The two semi-housings (61) are combined together to form a house, and the house has a handle (600) and a top case (610). The handle (600) is integrally formed with the top case (610). The handle (600) has a bottom end, an air input (611) and a recess (612). The air input (611) is defined in the bottom end of the handle (600). The body (62) is partially mounted inside top case (610) in the housings (61) and has a diameter, a front end, an outer surface, a recess (64) and multiple exhaust channels (640). The recess (64) is defined in the outer surface of the body and has a diameter. The diameter of the recess (64) is smaller than the diameter of the body (62). The exhaust channels (640) are respectively defined in the recess (64) for venting exhaust air. A rotor is mounted inside the body (62).

The muffler (70) is mounted inside the recess (612) defined in the handle (600). The muffler (70) may be any kind of a conventional muffler (70), and a second noise suppressor (71) is mounted around the muffler (70).

The first noise suppressor (80) is mounted inside the recess (64) as described above. Noise made by the pneumatic tool will be absorbed by the first noise suppressor (80) and the second noise suppressor (71) such that an optimum noise reduction feature is achieved.

Because the noise made the pneumatic tool can be absorbed by the noise suppressor (40, 40A, 40B, 71, 80) mounted around the recess (21, 64, 612) in the body (20, 61), the noise can be reduced to about 85 to 86 decibels, whereby the damage caused by the noise will be reduced and prevent a user from becoming annoyed and impatient.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A pneumatic tool comprising
a body having
a diameter,
a front end,
an outer surface,
a recess defined in the outer surface of the body and near the front end of the body and having a diameter smaller than the diameter of the body,
multiple exhaust channels respectively defined in the recess,
a rotor mounted inside the body and near the front end, and
a cylinder mounted inside the body and surrounding the rotor,
a chuck bracket mounted on the front end of the body,
an exhaust ring mounted in the recess in the body and forming a chamber between the recess in the body and the exhaust ring, having multiple exhaust channels defined in the exhaust ring, and
a noise suppressor mounted inside the chamber between the recess in the body and the exhaust ring, and made of material that absorbs sound and air.

2. The pneumatic tool as claimed in claim 1, wherein the noise suppressor is a loop.

3. The pneumatic tool as claimed in claim 1, wherein the noise suppressor is a belt having two ends, and two connectors mounted on the two ends.

4. The pneumatic tool as claimed in claim 1, wherein the noise suppressor is a belt having two ends that connect together by stitching.

5. The pneumatic tool as claimed in claim 1, wherein the noise suppressor is made of textile.

6. The pneumatic tool as claimed in claim 1, wherein the noise suppressor is made of resilient material.

7. The pneumatic tool as claimed in claim 1, wherein the noise suppressor is made of plastic material.

8. The pneumatic tool as claimed in claim 1, wherein the pneumatic tool further comprises
two semi-housings mounted together and each semi-housing having
a top case, and
a handle integrally formed with the top case, having
a bottom end,
an air input defined in the bottom end of the handle, and
a recess defined in the handle,
the body partially mounted inside the top cases in the semi-housings,
a muffler mounted in the recess in the handle, and
a second noise suppressor mounted around the muffler.

9. The pneumatic tool as claimed in claim 8, wherein the second noise suppressor is made of a material that absorbs sound and air.
